(19) United States
(12) Patent Application Publication
(10) Pub. No.: US 2014/0013108 A1
(43) Pub. Date: Jan. 9, 2014

(54) On-Demand Identity Attribute Verification and Certification For Services

(71) Applicants: Jani Pellikka, Oulu (FI); Petri Leukkunen, Oulu (FI); Ijaz Ahmed, Oulu (FI)

(72) Inventors: Jani Pellikka, Oulu (FI); Petri Leukkunen, Oulu (FI); Ijaz Ahmed, Oulu (FI)

(21) Appl. No.: 13/543,190

(22) Filed: Jul. 6, 2012

(51) Int. Cl. H04L 29/06

(52) U.S. Cl. 713/156

(57) ABSTRACT

An apparatus is caused to store identification data of a plurality of clients in memory; cause reception of information indicating at least one identifier of a device corresponding to a client requesting access to a service; verify the identity of the client device on the basis of the received identifier; detect whether or not the identified device is authorized to communicate with the apparatus on the basis of first predetermined criteria; upon detecting that the device is authorized, cause reception of in-formation indicating at least one identifier of the client from the identified device; verify the at least one identifier of the client on the basis of the received identifier and the stored identification data; and determine, on demand, whether to issue a certificate indicating the verifications on the basis of second predetermined criteria in order to enable the client to apply the certificate in accessing the service.

### FIELD

The invention relates generally to verification and certificate issuance.

### BACKGROUND

It may be important to authenticate a certain user (i.e. client) when the user is trying to access a certain server in the Internet. These servers, which require authentication of the user, may include, for example, bank servers, e-mail servers, or any server providing Internet services where personal data of the user is accessed. For the purposes of authenticating the user, the server may have the knowledge of the users' authentication data, such as passwords, log-in names, fingerprints or other biometric data, for example.

However, it may be that the users do not feel comfortable allowing the service providers to have such personal authentication data in their respective servers. Therefore, an improved solution is needed for authentication of users over the communication network.

### BRIEF DESCRIPTION OF THE INVENTION

According to an aspect of the invention, there is provided apparatuses as specified in claims 1 and 16.

According to an aspect of the invention, there is provided a method as specified in claim 18.

According to an aspect of the invention, there is provided a computer program product as specified in claim 19.

According to an aspect of the invention, there is provided a computer-readable distribution medium carrying the above-mentioned computer program product.

According to an aspect of the invention, there is provided an apparatus comprising processing means configured to cause the apparatus to perform any of the embodiments as described in the appended claims.

According to an aspect of the invention, there is provided an apparatus comprising a processing system configured to cause the apparatus to perform any of the embodiments as described in the appended claims.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents an authentication scenario according to prior art;

FIG. 2 shows a method according to an embodiment;

FIG. 3 shows a proposed authentication scenario;

FIG. 4 illustrates possible identifiers of the device and of the client, according to some embodiments;

FIGS. 5, 6A, 6B, 6C, and 8 present flow diagrams according to some embodiments; and

FIG. 7 depicts an apparatus according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

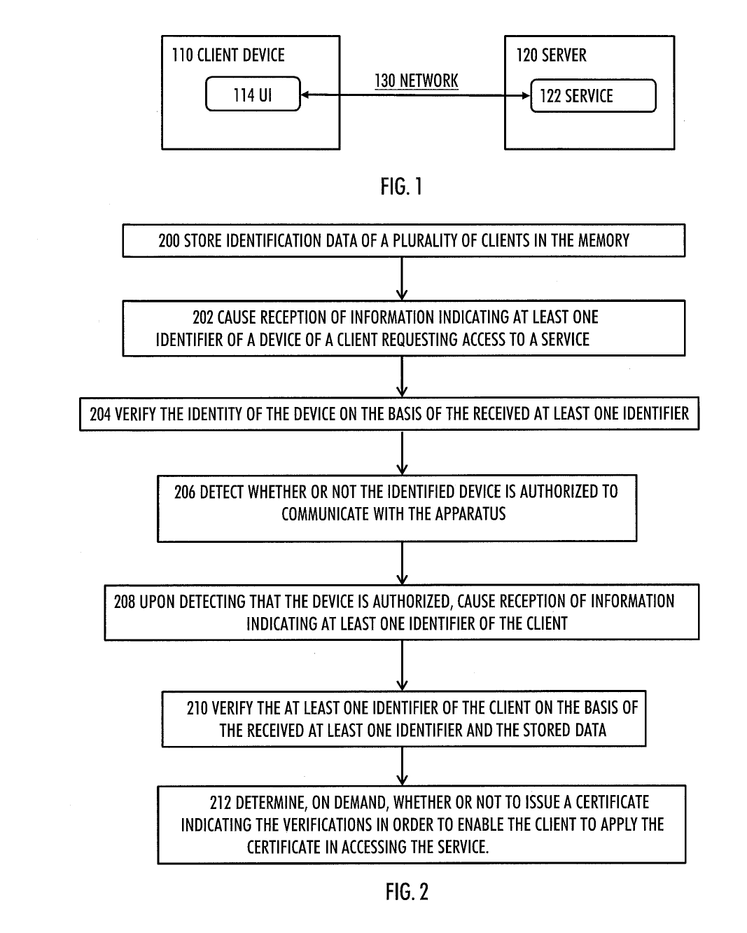

As said above, authentication of clients and devices by a network service may be required before the client may access the network service, such as an application residing on a server and accessible via the Internet. This is shown in FIG. 1, wherein a client device 110 request access to the server 120 where a certain network service 122 resides on. The client device 110 may comprise a user interface 114, such as a keypad, for typing a user name and a password, for example. These client identifiers may be provided to the server 120, wherein the service 122 may apply them in client identification/verification/authentication on the application layer where the service 122 is at. Naturally the client's device 110 and the server 120 may also comprise at least one processor and a memory, although not shown in FIG. 1. As the server 120 may in this way be aware of the client identity, the service 122 may determine whether or not to allow the client to communicate with the service 122 or not. It is also known to use, for example, fingerprints or voice identifiers instead of or in addition to passwords. However, such indication of important, personal data each time to a different service 122 being requested, is cumbersome and typically people do not feel comfortable doing so. Therefore it may be beneficial to come up with a solution where the data need not be given to the server 120, or at least a solution where the user may select which data is given to the server 120. An additional drawback of prior art authentication systems is that the scalability and the security is poor. For example, in order to enable the usage of new type of identifiers, each service may need to be separately reconfigured. For example, applying biometric identifiers may be cumbersome in the current authentication systems for different servers/services. Thus, an improved solution, which minimizes complexity and improves security framework is needed.

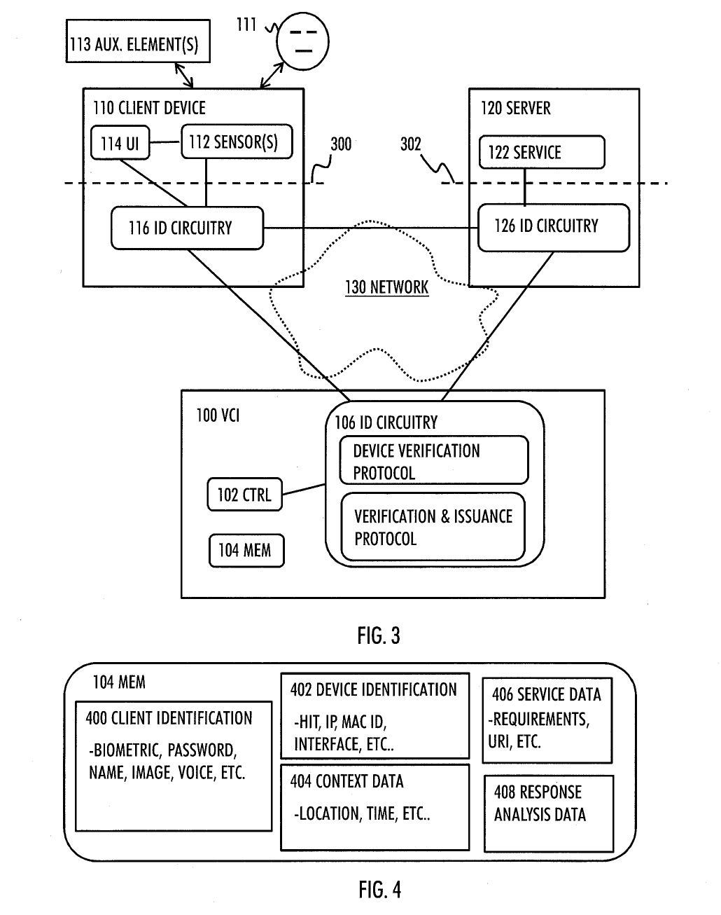

Therefore, it is proposed, as shown in FIGS. 2 and 3, to provide an apparatus 100 for verifying the identities of devices and clients and for issuing certificates to be applied by the clients in accessing at least one service 122. Therefore, the apparatus may be called a verification and certificate issuance (VCI) apparatus 100, or simply a verificator 100. As shown, the VCI apparatus 100 may comprise at least one processor 102 and at least one memory 104 including a computer program code, wherein the at least one memory 104 and the computer program code are configured, with the at least one processor 102, to cause the apparatus to store identification data of a plurality of clients 111 in the memory 104 in step 200. The identification information may be obtained from the plurality of clients 111 themselves. The VCI apparatus 100 may be an entity authorized by the government or any other reliable third party. This may make the client 111 more comfortable in providing personal identification data for storage to the VCI apparatus 100. The stored identification data may be in a digest form produced through a use of cryptographic one-way functions such as the cryptographic hash SHA2. A one-way cryptographic function takes a variable-length input (such as the provided identifier of the client) and outputs a fixed-length digest. Given the characteristics of the one-way cryptographic function, as known to a skilled person, it is computationally infeasible for any unwanted persons to find the provided identifier input from the cryptographic function. Thus, the identification data stored may be kept in the memory 104 in a secure way without danger of leakages of personal information to outsiders.

In step 202, the VCI apparatus 100 receives information indicating at least one identifier of a device 110 corresponding to a client requesting access to a service 122. The device identifier may be globally unique. In an embodiment, the identifier of the device 110 is a self-verifiable cryptographic identifier. An example of such identifiers may be a host identity tag (HIT) according to the host identity protocol (HIP), for example. Briefly, the HIP architecture proposes an alternative to the dual use of IP addresses as “locators” (routing labels) and “identifiers” (endpoint, or host, identifiers). In HIP, public cryptographic keys, of a public/private key pair, are used as the host identifiers. By using public keys, or their hash representations, as host identifiers, for example dynamic changes to IP address sets can be directly authenticated between hosts. Thus, the HIP may be used as a way to reliably identify the other device's (i.e. host's) identity, e.g., to make sure that the client's device 110 is which it claims to be. It may be advantageous to apply such self-verifiable cryptographic identifier as the other entity may be verified without any help from any other entity.

In an embodiment, the service 122 is a network service or a service locating in the network. The service may be provided by a server 120, as indicated in FIG. 3, for example.

In an embodiment, the identifier of the device 110/100 may be a static identifier, which is assigned to the device 110/100 by a certain entity. Such assignment may, in an embodiment, be given by a smart card coupled to the device 110, for example. The use of such smart card may be advantageous as it may enable ease of re-location of the same identifier. In another embodiment, the assignment of the static identifier may be fixed with the device 110. In an embodiment the identifier of the device may be a fully qualified domain name (FQDN) or the IP-address of the device.

In an embodiment, the identifier of the device 110 and VCI apparatus 100 may be a derived identifier having an ephemeral-character, i.e. the identifier is based on some other data. The identifier may be derived from, for example, a more permanent identifier such as a static public key or HIT of the client 111 or the VCI apparatus 100 with a certification of a 3^{rd} party, and/or a certificate document, etc. The device 110 may indicate such data to the VCI apparatus 100 which may derive the device 110 identifier and, thus, ensure that the device 110 is an authorized device 110 with which communication may be established to. In this case, the certificate issued by the VCI apparatus would be a so called implicit certificate. Such use of ephemeral identifier may be advantageous as any third person possibly listening to the network channels, marked with solid lines through the network 130 in FIG. 3, may not obtain knowledge of the static identifier as no static identifier is explicitly transferred as plaintext in the channel. Other benefits may include faster processing and lower network bandwidth usage.

In an embodiment, as shown in FIG. 3, there may be at least one auxiliary element 113 coupled to the device 110. The element may be a smart card, another device, etc. Each of these auxiliary elements 113 may have its own identifier and the identities of each of these auxiliary elements 113 may be verified as well in step 204. The identifier of the auxiliary device 113 may be a cryptographic identifier, which may apply the private-public key topology. In other words, it should be noted that one device 110 may have several identifiers associate to it, such as one identifier for the device 110 itself and one for each of the at least one auxiliary element 113, such as a smart card, coupled to the device 110. The VCI apparatus 100 may verify the identity of each accessory 113(smart card, for example) coupled to the device 110. Similarly, the client 111 may be associated with several devices 110, each of which may be identified and each of which may be coupled to at least one auxiliary element 113.

In step 204 of FIG. 2, the VCI apparatus 100 may then, as indicated above, verify the identity of the device 110 on the basis of the received identifier. In an embodiment, the verification is carried out on the network layer, wherein the network layer is a lower layer than an application layer. A skilled person is well aware of the different layers in the open system interconnection (OSI) model and, thus, the layers are not detailed here. As may be appreciated by a skilled person, there may not be any need to provide identification information to the application layer (where the requested service 122 resides on) but the identity verification is performed on the network layer. This may significantly simplify the verification because the service 122 itself need not be reconfigured each time the authentication procedure is updated, for example. However, in another embodiment, the verification is carried out on the application layer.

In an embodiment, the device 110 may be detected to belong to a certain group on the basis of the device identifier. For example, the device identifier may indicate that the device belongs to certain company's set of computers (based on the IP address, MAC address, CPU ID, for example).

In an embodiment, the VCI apparatus 100 may store identification data of a plurality of devices in the memory 104. After the VCI apparatus 100 has received the identifier information (such as an IP address or a cryptographic identifier, for example) from the client's device 110, the VCI apparatus 100 may, in step 204, verify the identity of (e.g. authenticate) the device 110.

It should be noted that the client's device 110 may also verify the identity of, or authenticate, the VCI apparatus 100 before performing any more data communication with the VCI apparatus 100. Such bidirectional authentication may be called mutual authentication. For this, the VCI apparatus 100 may also indicate its identifier to the client's device 110, wherein the authentication of the VCI apparatus 100 may also be based on the HIP protocol. This way, the client's device 110 may also obtain knowledge that the VCI apparatus 100 is legitimate. As with the client device, the identity of VCI apparatus may be a static or derived self-verifiable cryptographic identity, as explained later below. Like VCI, in some embodiments, the client's device 110 may require similar behavior from the network service 122, thus making the proposed approach multi-lateral in practice.

Looking at FIG. 3, the dotted lines 300 and 302 represent the division between the network layer, which is below the dotted lines 300 and 302, and higher layers, such as the application layer, which are above the dotted lines 300 and 302. FIG. 3 also shows the identification (ID) circuitries 106, 116 and 126 in each of the apparatuses 100, 110, and 120. The ID circuitry 106, 116 and 126 may be understood as a functional block comprising a processor and a memory storing software (ID daemons), which, when executed by the processor, may carry out the predetermined verification of identity protocol, such as the HIP-protocol for obtaining the host (device 100/110) identity and the identity verification and certificate issuance protocol, as will be explained, for example. In an embodiment, the processor 102 and the memory 104 are seen to be comprised in or coupled to the ID circuitry 106. The ID circuitry 106 may apply a device verification protocol, such as HIP, for verifying the identity of the client (and any auxiliary elements 113) and verification and issuance protocol (VIP) for verifying the identity of the client and for issuing the certificate, as will be described later. The other circuitries 116 and 126 may also apply similar protocols, although not shown, for identifying the device, and possibly the client, with which communication connection is to be established.

In step 206 of FIG. 2, the VCI apparatus 100 may thereafter detect whether or not the identified device 110 is authorized to communicate with the authentication apparatus 100 on the basis of first predetermined criteria. Thus, as the VCI apparatus 100 has the identity of the device 110 verified, the VCI apparatus 100 may decide whether the device 110 is authorized to carry out data transfer with the VCI apparatus 100. The first predetermined criteria for deciding may comprise, for example, is the identified device 110 in an access control list (ACL) stored in the memory 104 of the VCI apparatus 100. The ACL may be a list of those device identities which are accepted to exchange data with the VCI apparatus 100. Similarly, there may be a list of unauthorized device identities. These may refer to devices who are known (for example, based on history knowledge) to cause malfunctions or feed viruses to the other device communicating with such unauthorized device. It may also be that the predetermined criteria checks whether or not the identity of the device 110 is certified by a third entity, such as a government or some other reliable entity. One criterion may be that the identity of the device 110 is required to be a derived self-verifiable cryptographic identifier. Thus, in an embodiment, a certain level of reliability of the device identification is required. The reliability may be determined based on the type of device identification. For example, identity verification based on HIP may be more reliable than identification based on explicit IP-address. The certain level required may be predetermined by the VCI apparatus or the requested service 122, for example.

In an embodiment, regarding a case where the device 110 is coupled to one or more auxiliary element 113, the predetermined criteria may require that the device 110 need to be coupled to at least one specific auxiliary element 113. In other words, unless the VCI apparatus 100 is able to verify the identities of the device 110 and the at least one specific auxiliary element 113, the VCI apparatus 100 may decline the device 110 from communicating with the VCI apparatus 100 because the device 110 (without the specific auxiliary element 113) is detected to be unauthorized. Such specific auxiliary element 113 may comprise, for example, a specific smart card or a subscriber identity, SIM, card, or any other cryptographically verifiable identity such public/private key pair.

Upon detecting that the device 110 is unauthorized, the VCI apparatus 100 may block the access of the device 110 to the VCI apparatus 100. However, upon detecting that the device 110 is authorized, the VCI apparatus 100 may in step 208 cause reception of information indicating at least one identifier of the client 111. That is, the client 111 may cause the device 110 to transmit data related to the at least one identifier of the user 111 of the device 110. The identifier of the client 111 may also be called a characteristic feature of the client 111. The client 111 may be an individual person or an organization, for example. In other words, once the VCI apparatus 100 and the device of the client 110 have performed the mutual device authentication, the entities 100 and 110 may establish a secure communication connection through which the client identifier 400 may be indicated to the VCI apparatus 100. As said, the mutual device authentication may be carried out according to the HIP, or any other protocol applying authentication and key agreement, which is used to check the device certificate at both entities 100 and 110. The secure communication connection between the device 110 and the VCI apparatus 100 may be provided via an IPSec tunnel, or any other network solution known to a skilled person.

Thereafter, in step 210, the VCI apparatus 100 may further verify the at least one identifier of the client 111, possibly on the network layer, on the basis of the received at least one client identifier and the stored identification data. It may also be, in an embodiment, that only one or more of the at least one received client identifiers are verified. In yet further embodiment, the identity of the client is verified on the basis of the received at least one identifier and the stored identification data. However, it should be noted that identifying the identity may not be required as long as at least one identifier is verified. For example, in some cases it may be enough that the age of the client is verified, not the full identity of the client. As said in connection to step 200, the memory 104 may store identification data corresponding to several clients 111. The verification step 210 may comprise, for example, a comparison of the received at least one identifier with the identification database in the memory 104.

Let us take a closer look on what such at least one client identifier may comprise. As shown in FIG. 4, the memory 104 may store client identification data 400, device identification data 402, context data 404, and response analysis data 408. It is shown that the device identifiers 402 may comprise HITs (or more general, self-verifiable cryptographic private/public keys or representations of those), IP-addresses, medium access control (MAC) addresses, detected interfaces of the devices 110, derivables, etc. Verifying the device 110 and/or VCI apparatus 100 identities (mutual device authentication) has already been described above.

The response analysis data 408 may comprise, for example, thresholds for considering a client device an authorized device. For example, assume that the VCI apparatus 100 transmits an enquiry to the client's device 110. If acquiring the response from the device 110 takes a time which exceeds a threshold, then it may be detected that the client's device should not be authorized to communicate any further with the VCI apparatus 100. This is because it may be that the client's device is used as a fraud and the response is in fact generated by a third device acting “behind” the client's device 110. As another example, it may be detected that the response follows a certain pattern which is, based on history data, known to be falsified. It is clear to a person skilled in the art that the response analysis can be applied to any actor and to analyze not only technical but also e.g. knowledge, affection of client, or cognition related response analysis.

Let us now concentrate on the client identifiers 400 and the context data 404. In an embodiment, the at least one identifier of the client 111 comprises a biometric identifier. The biometric identifier may be fingerprint of the client 111, an image of the client 111 (taken by a web camera, for example), information related to the eye of the client 111, a voice of the client 111, or any other identifier which may undoubtedly and uniquely identify the person 111 (client). Especially for the case of biometric identifiers, the end-user is typically not willing to share the biometric data to possibly several different services 122, but the proposed VCI apparatus 100 may be significantly more trustworthy and, thus, preferable entity to which the biometric data may be given. As said, the data stored in the VCI apparatus 100 may be secured, for example, via cryptographic one-way functions. It should be noted that in an embodiment, the VCI apparatus 100 has an authorization issued by a government or another reliable entity, wherein the authorization indicates that the VCI apparatus 100 is authorized to collect information relating to such personal identification data. This may advantageously make the end-users more willing to share biometric data with the VCI apparatus 100.

In an embodiment, the at least one client identifier comprises at least one of the following: a password, a name, an email address of the client 111. The password is typically determined by the client, thus providing reliable indication that the person who knows the password is the person who he/she claims to be. The name may not be as strong identifier as the password, but nevertheless, in some scenarios, knowing the user name or the actual name of the client may be enough for identification. In an embodiment, the email address may work as the identifier of the client.

In an embodiment, the identifier of the client may be, for example, at least one device identifier, a geographical location, organization, time or date for the connection attempt, for example. As said, the device identity may imply the user identity. This may be the case, for example, with mobile phones, as the device 110, which are typically owned by a single person. Also, the location or the organization indicated may be enough for identifying the person, possibly with the aid of the identified device identity. The time or date of the verification attempt may also aid in verification of the user 111 because it may be that certain users are expected to attempt connection to the VCI apparatus 100 at a certain times. It may also be that such time or data is previously allocated to a user 111 so that the user 111 needs to access the VCI apparatus 100 at the allocated time and/or date. The activity of the client 111 may be used in verifying the identity of the client.

In order to enable the capturing of the at least one identifier, the client device 110 may comprise at least one sensor 114, such as a fingerprint sensor or a camera. It should also be noted that information relating to several identifiers may be sent to the VCI apparatus 100. The required amount of identifiers may depend on the reliability of the identification needed by the service 122, for example. Applying more identifiers may provide more reliable user identification.

Looking at FIG. 3, from the client device's 110 point of view, the ID circuitry 116 may provide an interface for the client 111 to provide identifiers related to the client 111. It may be, for example, that the identifier of the client 111 is sent as encrypted to the VCI apparatus 100. In such scenario, the ID circuitry 116 may provide the capability for the sensors 112 to send raw identifier data (such as fingerprints) to the ID circuitry, and the ID circuitry 116 may perform the encrypting of the data prior to transmission of the identifier data to the VCI apparatus 100. The ID circuitry 116 may also detect the presence of new type of sensors 112, for example.

Thereafter, in step 212 of FIG. 2, the VCI apparatus 100 may determine, on demand, whether or not to issue a certificate indicating the verifications of the identifiers of the client and of the device on the basis of second predetermined criteria in order to enable the client to apply the certificate in accessing the service. The certificate issuance thus takes place on demand, i.e. on the basis of a request from the client 111. Such dynamic certification issuance may be advantageous as the client 111 may perform the actions any time. The second criteria may indicate, for example, that a certain client identifier and/or identity is approved only from a certain device identity, such as the device 110 with zero or more smart cards 113 coupled to the device 110. The VCI apparatus 100 may store such predetermined client-device pairs in the memory 104. If the certain client 1 and/11 or client identifier does not match with the predetermined device 110 or with the predetermined device 110 paired with a specific at least one auxiliary device 113, the VCI apparatus 100 may decide not to issue the certificate. In an embodiment, where the device 110 is detected to belong to a specific group, it may be required that the client's verified identifier may need to match with one of the identities of the group members, for example. A further or an alternative example criterion for certificate issuance may be that the client identifier verification needs to be successfully determined before issuance of the certificate, for example. More criteria for certificate issuance will be given later in connection with different embodiments.

In an embodiment, the client identifier verification may take place on the network layer which may be advantageous over the identification on the higher layers. The ID circuitry 106 may apply, for example, a verification and issuance protocol (VIP), i.e. client authentication and certification issuance protocol, in verifying the client's 111 identity. As an alternative, the client identity may be verified by applying identifiers transmitted over a protocol, such as transmission control protocol (TCP), or user datagram protocol (UDP). It may be noted that some firewalls, for example, do not allow any other protocols than the TCP and/or the UDP to access, thus use of such protocol may be advantageous. In an embodiment, the VIP is performed on top of the TCP or UDP. In an embodiment, it is also possible to run both, VIP and the device verification protocol, directly over the IP layer as well.

In an embodiment, the device verification protocol and VIP may be performed on a lower level than the IP layer as well, e.g. directly on the link layer (layer 2). This kind of operation is suitable for e.g. “plug-in” use cases in sensor and body area networks, where the VCI device and client device may be connected/paired on the same link using some wireless personal area network (WPAN) technology. Here, the role of the device verification protocol is to verify the identity of the correspondent device and determine whether to allow the connection/pairing, as well as to negotiate keying material for the link layer encryption and integrity protection (i.e. secure radio channel). The VIP, in turn, after a successful run of the device verification protocol, is performed in the secure (link layer) channel as described earlier. It is also possible to run these two protocols on different layers, e.g. VIP on the IP layer and device verification protocol on link layer.

However, in an embodiment, the identifier and/or identity of the client 111 need not be verified. Such scenario may present in any machine-to-machine cases characterized by the lack of client 111. In such case, the decision of whether to issue the certificate or not, may be based on the verification of the device 110 identity. For example, it may be that the certificate is issued only if the device 110 is identified together with a certain at least one auxiliary element 113. In an embodiment, the device 110 identity may be required to be a certified derived identity; possibly by a client or other 3^{rd} party.

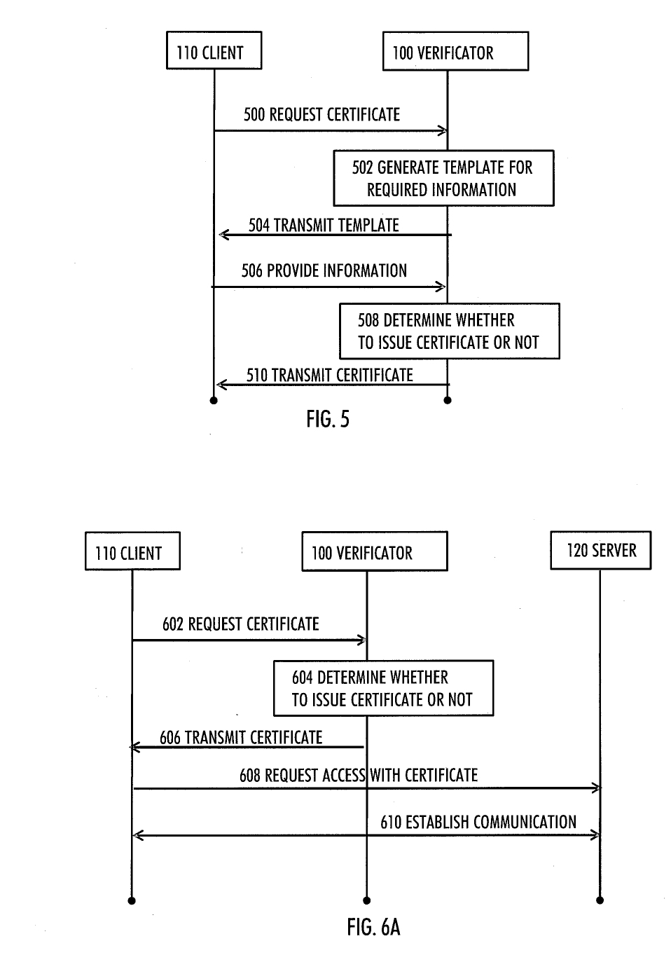

As shown in FIG. 5, an example method for certificate issuance is provided. In the embodiment of FIG. 5, the client 111 requests certificate in step 500 by transmitting a request of certificate to the VCI apparatus 100 via a recently established secure communication connection (thus, the device 110/100 identities may have already been detected and authenticated). In step 502, the VCI apparatus may generate a template of the certificate, wherein the template may have fields which the client 111 and/or client's device 110 need to fulfill. Thus, in step 504, the VCI apparatus 100 transmits the template to the client's device 110 and, in step 506, the client 111 replies by giving the requested information in the template. This may be one possible point of time in which the response analysis referred to with block 408 of FIG. 4 may be applied. In practice, the client 110 may transmit the same template back to the VCI apparatus 110. However, now the template is filled by the client 111 and/client's device 110. The information requested may be, for example, fingerprint data, voice sample, a password, a user name, metadata, etc. The metadata may comprise, for example, a new email address of the client 111. The VCI apparatus 100 may determine which type of metadata is accepted, if any, by generating a certain type of template. In step 508, the VCI apparatus 100 may then determine whether or not to issue the certificate to the client 111. When the information sent by the client 111 is approved, e.g. all required fields of the template are filled and the information filled matches with the database (memory 104) of the VCI apparatus 100, the VCI apparatus 100 may, in step 510, transmit the certificate to the client 111. The information may be said to match with the database 104 when the VCI apparatus 100 is able to verify at least one identifier of the client 111, as described with reference to step 210 of FIG. 2, for example.

In an embodiment, the device 110 may already comprise a certain valid certificate when requesting for another certificate. In such case, the VCI apparatus 100 may take the previous certificate as basis for generating the new certificate. For example, some data of the previous certificate may be applied also for the new certificate without the user 111 providing the data, such as fingerprint data, again. Alternatively, VCI apparatus may configure the new certificate to comprise a reference to the previous certificate or certificates which the client device 110 also presents to the server at the time of connection.

In an embodiment, the existence of a certificate is prerequisite for issuing a new or updated certificate. In other words, the connection to the VCI apparatus 100 may be denied unless the device 110 has an earlier certificate to present. Such embodiment may be advantageous as falsifying the previous certificate may be a cumbersome issue. Thus, the security of the system may be improved.

In an embodiment, there are several VCI apparatuses 100, each of which may be authorized to issue certificates to clients. In such case, it may be that one VCI apparatus handles the certificate issuance with respect to biometric data, for example, whereas another VCI apparatus complements the same certificate with another type of data, such as passwords, or generates another certificate.

In an embodiment, the VCI apparatus 100 may configure the certificate to comprise at least one reference to one or more earlier issued certificates comprising information indicating at least one identifier of the client and/or of the device, wherein the information of the earlier issued one or more certificates is verified by the present apparatus or another apparatus. Thus, a certificate used in accessing a service 122 may comprise information indicating the verification of the identifiers and/or reference to another, existing certificate.

In an embodiment, the reference may be to another certificate belonging to an authorized client. It may be that certain level of linkage is needed between the two clients. For example, a child may apply his/her parent's certificate to access a certain service 122.

In an embodiment, the VCI apparatus may act as a proxy or a relay for the device verification protocol and/or the VIP protocol. This makes scenarios possible, where the ID circuitry 126 is deployed in and acts as a gateway at the border of a network that requires access authorization, but the VCI apparatus resides inside the network, behind the gateway. In this case, the server 120 and ID circuitry 126 may need to forward VPI messages between the client device 110 and the VCI apparatus 100. Other alternative is that the server 120, acting as a gateway, is a delegate carrying out the VIP communication with the VCI apparatus 100 for the behalf of and authorized by the client device 110, with no need to establish an exchange of VIP or any other messaging between the client device 110 and the VCI apparatus 100 through the gateway. Let us next consider the issued certificate. In an embodiment, the certificate comprises the (possibly static) verified identity of the client's device 110. The identity of the device 110 may thus be certified by the VCI apparatus 100. In an embodiment, a certified identifier of the client 111 itself is comprised in the issued certificate. In another embodiment, the certificate comprises information of the type of the client identifier(s) which was/were used in verification of the identities of the client 111 (e.g. a fingerprint, a face image, voice, password, etc.) and of the device 110 (e.g. HIT, IP-address, location, etc). Thus, the at least one identifier itself may not be provided in the certificate. Avoiding the transmission of the identifier itself may be advantageous as typically people do not want to have their personal data to be given to the services 122. For example, people typically do not feel comfortable in giving their biometric data, such as fingerprints, to the plurality of different services 122. Also, from overall identity theft and security risk perspective, such avoidance is preferred, because loosing this kind of information would jeopardize individuals in all the systems using biometric data. Also, such avoidance may improve the security aspects significantly as third parties cannot get the identifier information from the certificate.

In an embodiment, the issued certificate may comprise metadata of the VCI apparatus 100, such as the device identifier of the VCI apparatus 100, the authorized character of the VCI apparatus 100 (i.e. which entity has authorized, if any, the VCI apparatus 100 to perform authentication related functionalities), etc. In an embodiment, the certificate may comprise metadata of the client 111 and/or client's device 110. Such metadata may be, for example, the name of the client 111, the birthdate of the client 111, the email address of the client 111, the social security number of the client 111, the home city/village of the client 111/device 110, an organization of the client 111/device 110, just to mention a few non-limiting examples.

In an embodiment, the certificate may comprise encrypted data and data sections meant for and decryptable only by the ID circuitry 126 in the server 120. The certificate may also have such a construction that it is possible to create sub-certificates from data within the certificate, while still preserving issuer's signature or other verification for the particular extracted data.

The client 111 and the client's device 110 may apply the certificate when accessing certain service 122 via the network 130, as shown in FIG. 3. In an embodiment, the same certificate may be usable for a plurality of services 122. I.e. the VCI apparatus 100 may have configured the certificate to be applicable with respect to each network service the client is accessing to. By applicable it is meant that the certificate does not, as a default, rule out any service. Thus, the client may try to access several services 122 with the same issued certificate without re-authentication between the accesses of the plurality of services 122. It may be noted that, from the server's 120 point of view, the ID circuitry 126 may provide an interface to the services 122 through which the services 122 access the information presented to them in the issued certificate by the client 111 during access request.

Let us look at FIG. 8, where the client' device 110 requesting the access to the service 122 is shown. In step 800, the device 110 request access to the service 122. Such access request may also comprise mutual authentication of devices 110 and 120, i.e. of the client's device 110 and the server 120. Such mutual device authentication/verification may be performed on the basis of HIP, for example. It may also be that the identity of the server 120 is verified/certified by the same VCI apparatus 100 according to any of the embodiments presented. Thus, the identity of the server 120 may be certified as well and the client's device 110 thus acquires knowledge that the server is which it claims to be.

In step 802, the service 122, or the server 120 of the service 122, may reply by indicting the requirements needed for the service 122 access. In other words, the service 122 may transmit information indicating a ticket to the device 110. The ticket may indicate which requirements need to be fulfilled before the access is granted, e.g. which type of certificate is needed, what are the requirements with respect to the type of sensor 112 (e.g. the manufacturer of the sensor 112), what the certificate need to comprise, which entity (e.g. the VCI apparatus 110) need to have issued the certificate, what is the reliability level of the required certificate (reliability is explained in more details later), which identity verification methods have been applied (such as HIP, voice, face, fingerprint, password, etc), to mention only few non-limiting examples. The ticket may also have a predetermined validity period during which the required certificate corresponding to the requirements laid down in the ticket needs to be presented. The ticket may also have information on the target device 110 in order to avoid unauthorized usage of the ticket. As said, the ticket may imply which entity (e.g. the VCI apparatus 110) need to have issued or needs to issue the certificate in order for the client to access the service 122. The ticket may be signed/certified by the server 120 or by the service 122.

Thereafter, in step 804, the client's device 110 may determine whether such certificate, or any certificate, is currently present, e.g. does the device 110 currently comprise any certificate acquired from the VCI apparatus 100, for example, As may be noticed, such presence of at least one certificate may be possible as the device 110 may have previously asked for a certificate from the VCI device 100 in order to access another service or just in case such certificate is needed at some point.

Upon detecting that such certificate is not present, the device 110 may in steps 806A and 806B acquire such certificate from the VCI apparatus 100 according to any of the embodiments described. The requested certificate may be according to the requirements of the service 122 indicated in the received ticket. Same may apply when there is a certificate present for use of the device 110 but the present certificate does not match with the requirements indicated with respect to the reliability, for example. Thus, a new certificate may be needed from the VCI apparatus 100. In this case, step 808 may be omitted. Thereafter, in step 810, the client may request connection establishment to the service 122 on the server 120. In case the service 122 finds that the certificate is in order (for example that certain reliability requirement is met and/or the client's verified identifier/identity indicates that the client is an authorized client of the service 122), the server 120 and the device 110 of the client 111 may establish a communication connection in step 812.

However, upon detecting that a certificate is already present and that the certificate matches with the requirements of the service 122, the device 110 may not need to acquire a new certificate but apply the existing certificate for the connection establishment in steps 810 and 812. Thus, in this case steps 806A, 806B, and 808 may be omitted.

In yet another embodiment, upon detecting that a certificate is already present but the certificate is “over-qualified” for the purposes of the service 122, there may be a need to re-generate, compile or extract a sub-certificate from the present certificate. It may be, for example, that the current certificate present includes information which is not needed by the service 122. Such information may be, for example, email address of the client 111, fingerprint data of the client 111, etc. In such case, the additional information, which is not required by the service 122, is advantageously not transmitted to the service. Therefore, the device 110 may, in step 808, itself generate such sub-certificate comprising only the required parts of the present certificate, for example, by extracting only those required parts from the present certificate. Alternatively, the device 110 may, in step 808, request the VCI apparatus 100 to provide, or generate, or extract such sub-certificate. Thus, in this case the steps 806A and 806B may be omitted from FIG. 8. Thereafter the device 110 may apply the acquired sub-certificate for the connection establishment in steps 810 and 812.

Therefore, it may be appreciated by a skilled person that the same certificate may be usable for a plurality of different services 122. This may be performed by accessing one service 122 with the certificate A and another with the same certificate A. Alternatively, the second service may be accessed with a sub-certificate of A, for example, wherein the sub-certificate may be generated by extracting some of the fields of the certificate A to the sub-certificate.

In an embodiment, the VCI apparatus 100 may determine the type of the at least one identifier and, further, determine the reliability of the identification on the basis of the type of the at least one identifier and third predetermined criteria. Thereafter, the VCI apparatus 100 may configure the certificate to comprise information indicating the type and/or reliability of the verification with respect to the at least one received client identifier in order to allow the service 122 to determine whether to establish a communication connection to the device 110 of the client 111 or not.

The reliability of the identification may refer to the identifier of the device 110 and/or the client 111. The criteria here may, in an example embodiment, be that verification based on a password is not as reliable as one based on voice of the client 111. On the other hand, verification based on a fingerprint may be more reliable than the one based on voice. With respect to the reliability of the device authentication/identity verification, the criteria may be that device identified using HIP-protocol is more reliable than one applying the location of the device 110, for example. The third predetermined criteria may be based on empirical derivation and examination of which types of identifiers are most difficult to falsify and which are the easiest, for example. In addition, in an embodiment, the number of the applied identifiers may affect the reliability. For example, level 1 reliability may be obtained when the identity verification of the client 111 is based on a facial image, level 2 may be allocated when the identity verification of the client 111 is based on a facial image and a password, and a certificate having a level 3 reliability (i.e. security) may be presented when the identity verification of the client 111 is based on a facial image, a password, and an identification of a certain device 110. The service 122 may then acquire the reliability level from the presented certificate and, based on the level, either grant or decline the access to the service 122. The reliability level may aid in optimizing a false acceptance rate and a false rejection rate, for example.

Thus, it should be noted that one certificate may have only one reliability level or each of the identifiers forming the basis of the certificate may have an own reliability level indicated.

In an embodiment, the service 122 may, when granting an access, modify the content of the service 122 shown to the client 111 if the level of the certificate is high enough for granting an access but not high enough for accessing all the features of the service 122. A skilled person may appreciate that the service 122 need not know anything about the identifiers applied but the mere information of the level of the certificate is enough. This may simplify the configuration at the server 120 end.

As said, it may be that the certificate is, in general or by default, valid for more than one service 122. However, it may be that some of the services 122 the client 111 tries to access to (with the issued certificate) is more stringent than another service 122. In such case the more stringent service(s) 122 may deny the access unless a new certificate which meets the service's 122 requirements is obtained by the client 111 from the VCI apparatus 100. For example, one service may require a more secure and reliable certificate than another. In other words, the device 110 having a certificate with a certain reliability X, may apply the same certificate (or part of the same certificate) in accessing all the services 122 which do not require a certificate with a higher reliability than X. However, a service which does require a higher reliability may decline the access or modify the content of the service 122 unless the client's device 110 provides another certificate with the required, higher reliability.

It should be noted that the proposed solution is significantly different than, for example, single sign-on (SSO) systems. SSO is a property of access control of multiple related, but independent software systems. With the SSO property, a user logs in once and gains access to all systems without being prompted to log in again at each of them. In the SSO, or any prior art solution, the individual data, such as passwords, fingerprints, etc. are stored in each of the servers 120/services 122 as well as in the client's device 110. However, as said earlier, such distributed storage of individual data is not desired and preferred. In this regard, the proposed solution may be called a multi-sign on (MSO) rather than SSO, as, in some embodiments, the same certificate is applicable to a plurality of services 122 as explained above.

In an embodiment, the certificate may be valid for only specific services 122 or for a single specific service 122. In an embodiment, the VCI apparatus 100 may store data indicating the required reliability of the verification with respect to the each network service 122 in the memory 104. Such data may be obtained from the plurality of services 122 and stored as the service data 406 of FIG. 4. The data 406 may also comprise information related to the URIs of the servers 120. Although the VCI apparatus 100 need not necessarily acquire the information regarding the service 122 the client is requesting access to, in an embodiment, the VCI apparatus 100 does obtain such knowledge, for example, when the client requests the certificate. In such case, the VCI apparatus 100 may determine what the requirements with respect to the requested service(s) 122 are. Thereafter, upon detecting that the reliability of the identification does not meet the requirement corresponding to the requested network service(s) 122, the VCI apparatus 100 may determine not to issue the certificate. On the other hand, if the requirements are met, the certificate may be issued with respect to those services 122/that single service 122 only.

In an embodiment, the VCI apparatus 100 may store data indicating authorized clients and/or devices 110 with respect to a plurality of services 122 in the memory 104. The VCI apparatus 100 may cause reception of information from a specific client 111, wherein the information indicates the at least one service 122 the client requests access to. Thereafter the VCI apparatus 100 may determine whether or not the client and/or device is an authorized client 111 and/or device 110 with respect to the at least one requested network service 122. Upon detecting that the client 111 and/or device 110 is an authorized client 111 and/or device 110 for at least one of the requested at least one network service 122, the VCI apparatus 100 may issue the certificate. In addition, the VCI apparatus 100 may configure the certificate to be valid only for those at least one network service 122 regarding which the client 111 and/or device 110 is an authorized client 111 and/or device 110. In other words, the VCI apparatus 100 may check whether the device 110 and/or the client 111 is unauthorized to certain at least one service 122. This check with respect to the device identity may be performed even before the client 111 identification is performed. If the device 110 is not allowed to access the requested service, the VCI apparatus 100 may immediately decide not to issue the certificate even without identifying the client 111. The network service 122 may be identified based on the identity of the service 122, the uniform resource identifier (URI) of the service 122, the FQDN of the service 122, for example.

In an embodiment, a certain service 122 may have a list of non-authorized clients 111 and/or devices 110. Such list may also be used by the VCI apparatus 100 when determining whether or not to grant the certificate to the requesting client 111. Alternatively, the VCI apparatus 100 may grant the certificate but arrange the certificate to comprise information according to which at least one service 122 is not accessible with the issued certificate.

In an embodiment, each certificate may be assigned, by the VCI apparatus 100, a predetermined validity period in time domain. The length of the validity period may be based on at least one of the following: the requirements set by the provider of the network service 122, the reliability of the type of the identifier, etc. In another embodiment, each verified identifier of the client 111 and/or device 110 is given a validity period. The time period may specify the start time and date and the expiration time and date of the certificate. For example, a certificate with a high reliability may be given a longer validity period than one based on password identification. Also, the service 122 may have requirements with respect to the time/date of the issued certificate. Some services 122, such as Internet services of a bank, may require that the client 111 has been issued with the appropriate level certificate fairly recently, for example. It should be noted that the level of the certificate or other contextual information in the certificate may affect the validity period of the certificate.

In an embodiment, the validity period is not given, but the service 122 may itself detect when the certificate is issued on the basis of the issuance data/time and then determine whether or not the certificate is still valid for the service 122.

In an embodiment, the VCI apparatus 100 receives information from at least one network service 122, wherein the information indicates predetermined characteristics with respect to clients 111 and/or devices 110 with which the network service 112 prefers to interact with. These characteristics may be selected so that the characteristics typically belong to certain types of clients 111 or devices 110, for example. As an example, when the provider of the service 122 is located in Oulu, Finland, one of the indicated characteristics may be that the identified client 111 or device 110 should be located in Oulu, Finland. Such location data may be acquired from the client 111 or the from the device's 110 static identifier. Another example may be that the identified client 111 needs to be verified by at least a certain level of reliability, e.g. the client 111 needs to be able to present a certificate having a certain level of reliability, for example. Thereafter, upon detecting that at least one identified client 111 and/or device 110 matches with the indicated predetermined characteristics, the VCI apparatus 110 may transmit information indicating the identity of the at least one client 111 and/or device 110 to the network service 122. In this way, the service 122 may be notified whenever an interesting and/or potential device 110 and/or client 111 is identified. As a result, the network service 122 may then request the client 111/device 110 to establish a communication connection with the service 122, or otherwise contact the client/device 110. I.e. the initiation of the communication channel establishment between the server 120 and the client's device 110 may come from the server 120/service 122.

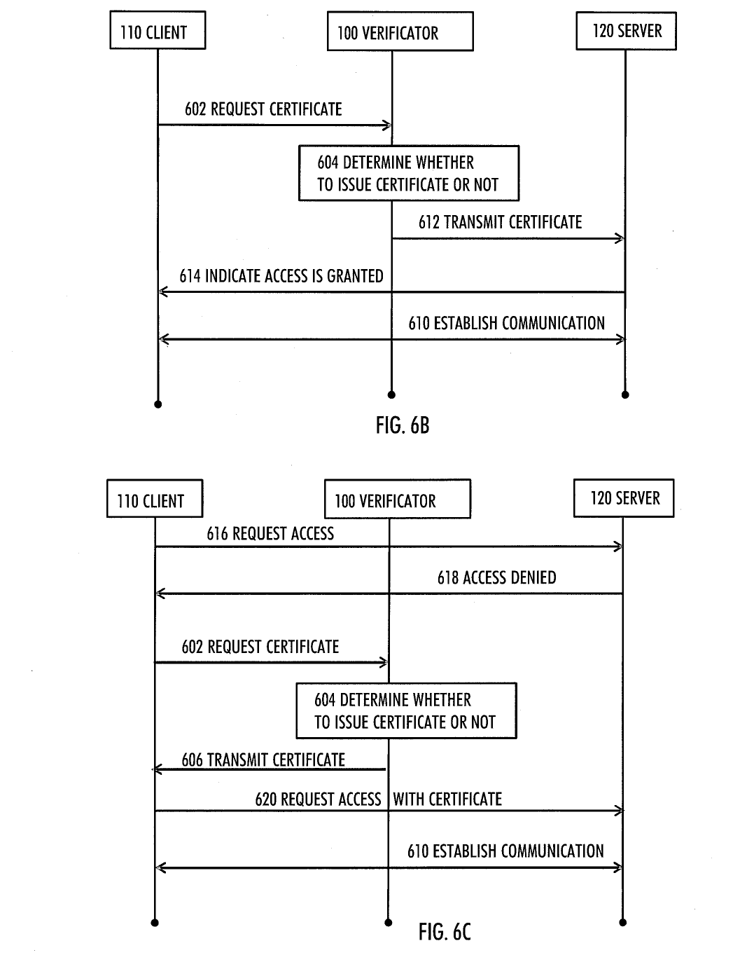

FIGS. 6A to 6C illustrate example flow diagrams between the client's device 110, the VCI apparatus 100 and the server 120 (in which the service 122 is). In all of the FIGS. 6A to 6C, it is assumed that a secure communication connection may be established between the client's device 110 and the VCI apparatus 100, e.g. the mutual device authentication may be or is already carried out. Starting with FIG. 6A, the client's device 110 may, request the certificate in step 602. For this, the sensors 112 of the client's device 110 may be used for detecting at least one client identifier (such as biometric identifier) of the client 111. Thereafter, the VCI apparatus 100 may in step 604 determine whether or not to issue the certificate with certain verified identifiers to the client. If everything is in order, the VCI apparatus 100 may in step 606 issue the certificate. Thereafter, in step 608, the client may request connection establishment to the service 122 on the server 120. In other words, the client may request access to the service 122. In case the service 122 finds that the certificate is in order (for example that certain reliability requirement is met and/or the client's identity indicates that the client is an authorized client of the service 122), the server 120 and the device 110 of the client 111 may establish a communication connection in step 610.

FIG. 6B differs from 6A in that, in this example embodiment, the VCI apparatus additionally or instead transmits the certificate regarding a certain client 111 and device 110 to the server 120 in step 612. The server 120 may then in step 614 indicate to the client 111 that access to the service 122 is granted. Thereafter, in step 610, the communication connection may be established.

FIG. 6C illustrates still another example embodiment. In this embodiment, the client 110 first, in step 616, requests access to a certain service 122 on the server 120. As the service 122 may, in step 618, deny the access due to lack of client's certificate, the client 111 (or the client's device 110) and the VCI apparatus 100 may in steps 602 to 606 perform the actions as described earlier. It should be noted, that as described with respect to FIG. 8, the service 122 may provide a ticket to the client's device 110 so that the device 110 knows what type of certificate is needed. Thereafter, the client 110 may, in step 620, request the access to the service 122 again. However, this time the client 110 may have an issued certificate to present. As a result, in step 610, the connection may be established.

In an embodiment, looking from the client's device's 110 point of view, the device 110 may detect an input of at least one identifier of the client 111. The client may input such identifier with the at least one sensor 112 or via the user interface 114, for example. The device 110 may then request the certificate for accessing at least one network service 122 from the VCI apparatus 100. In order to enable this, the client's device 110 may cause transmission of information indicating the at least one identifier of the client 111 and (or the device 110 to the VCI apparatus 100. In case the certificate is issued, the device 110 may receive the issued certificate from the VCI apparatus 100. Then the device 110 may request connection establishment with the at least one network service 122 on the basis of at least part of the issued certificate.

In an embodiment, the client's device 110 may cause transmission of information indicating at least one identifier of the device 110 to the VCI apparatus 100. The device 110 may further cause transmission of information indicating at least one identifier of the client 111 corresponding to the device 110 to the VCI apparatus 100. Thereafter, or before the preceding steps, the client's device 110 may request a certificate from the VCI apparatus 100. Thereafter, the device 110 may cause reception, on the basis of the request and provided identifiers, an issued certificate indicating the verifications of the identifiers and apply the certificate in accessing a service requiring at least part of the certificate. Further, in an embodiment, the device 110 may extract at least one information piece from the issued certificate and generate a sub-certificate from the extracted at least one information piece, as has been explained earlier. The client's device 110 may then apply the sub-certificate in accessing a service. The service may in this case require only part of the contents of the whole certificate, i.e. a sub-certificate is sufficient and adequate for the service. This may be advantageous so that the contents of the whole, or parent, certificate need not be given to the service.

In an embodiment, looking from the service's 122 point of view, the network service 122 may receive information indicating a request for communication establishment from a client 111. The request may comprise the certificate being presented. Thereafter, the service 122 may determine whether or not to accept the request on the basis of the presented certificate. In case the certificate is in order, the connection may be established. If not, the service 122 may reject the request, or modify the visible content of the service 122 to the client 111.

In an embodiment, the VCI apparatus 100 may store identification data corresponding to a new type of client identifier of the plurality of clients 111 in the memory 104. The VCI apparatus 100 may also be reconfigured to perform the identification of the client 111 on the basis of the new type of identifier. This may be advantageous because it may enable the usage of the new type of identifiers without reconfiguring the network service 122 to handle new type of identifiers. For example, when the level of reliability of the certificate is monitored at the service's 122 end, the service 122 need not necessarily know what the certificate comprises or on which identifiers it is based on. All that is required is whether the certificate fulfills the criterion with respect to reliability level. The knowledge of the actual content behind the level is not needed by the service 122. This may simplify the usage of new type of identifiers and authentication methods without reconfiguring the service 122 itself. Only the ID circuits 106, 116 and 126 of FIG. 3 may need to be reconfigured to manage with the updated circumstances. Thus, the ID circuit 106, 116 and 126 may be coupled or equipped with new plug-ins, such as with new software, which may enable the ID circuit 106, 116 and 126 to manage the new identifiers, etc.

It may be that the security level of a service 122 is increased. This may be due to the fact that hackers may learn how to falsify certain type of identifiers which have previously been considered as secure. The service 122 may indicate the client that new type of identifier is needed after a preset date, for example. In order to enable the use of new identifiers for the, the VCI apparatus 100 may need to be trained for managing the new type identifier. For this, the clients 111 and devices 110 may provide the VCI apparatus 100 with examples of the new type of identifiers, such as face images of the client taken in different illuminations, in different angles, etc. The VCI apparatus 100 may also request such new images if the corresponding training database is not adequate yet. The VCI apparatus 100 may then practice the identification and identifier/identity verification based on the images in the database. It may be advantageous to perform such training of the VCI apparatus 100, as then the new type of identifier may be reliably taken in to use after the preset date. For example, it may be that the false rejection rate and the false acceptance rate of the verification with respect to the new type of identifier may have certain predetermined target values which need to be met before the new type of identifier may be taken into use in that specific VCI apparatus 100. In an embodiment enrollment training e.g. creation or addition of identifiers may require authorization by e.g. a referral certificate, as mentioned earlier, when using the VCI apparatus 100 in accessing a service.

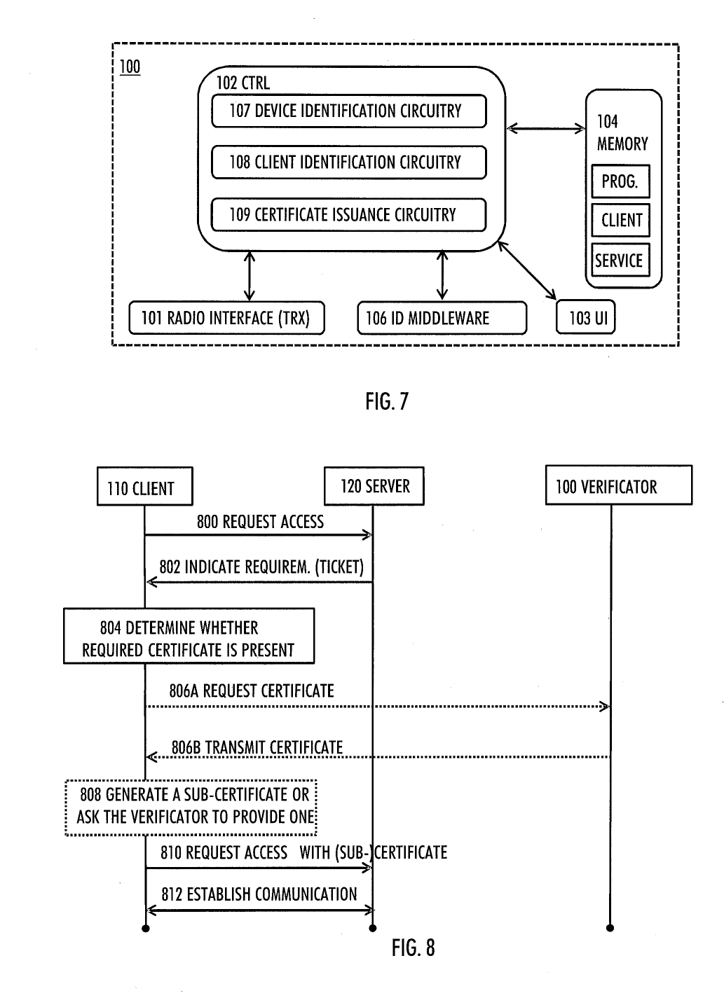

Let us take a closer look at the VCI apparatus 100. An embodiment, as shown in FIG. 7, provides the VCI apparatus 100 comprising a control circuitry (CTRL) 102, such as at least one processor, and at least one memory 104 including a computer program code (PROG), wherein the at least one memory 104 and the computer program code (PROG), are configured, with the at least one processor 102, to cause the apparatus 100 to carry out any one of the embodiments presented. It should be noted that FIG. 7 shows only the elements and functional entities required for understanding a processing system of the apparatus 100. Other components have been omitted for reasons of simplicity. It is apparent to a person skilled in the art that the apparatus may also comprise other functions and structures.

In an embodiment, the apparatus 100 may comprise, e.g., a computer (PC), a laptop, a tabloid computer, a cellular phone, a communicator, a smart phone, a palm computer, computer cluster, virtual machine, or any other communication apparatus. Alternatively, the apparatus 100 is comprised in such a device. Further, the apparatus 100 may be or comprise a module (to be attached to such device) providing connectivity, such as a plug-in unit, an “USB dongle”, wireless unit, or any other kind of unit.

Physically the apparatus 100 is, in an embodiment, a functional unit, which is physically separated from the server 120 and from the clients' device 110. However, in another embodiment, the VCI apparatus 100 may be comprised partly or completely in the server 120 and/or in the clients' device 110. For example, when the apparatus is in some client's device 110, the authentication apparatus 100 may perform its own processes inside the client's device 100. The operations related to the client's device 110 are in any case separate actions from the actions related to the VCI apparatus 100. Therefore, a mutual inter-process communication interface may be applied for the communication between the client's device's 110 processes and the VCI apparatus 100 processes. The protocol applied for communication establishment may be the same as if the apparatuses 100 and 110 were located in separate physical locations. The protocol applied for communication establishment may be used to ensure that the identities of the processes inside the same device 110 are valid before establishing the inter-process communication connection. Thereafter, the process may continue as described earlier by identifying the client 111 of the device 110.

As said, the apparatus 100 may comprise a control circuitry 102, e.g. a chip, a processor, a micro controller, or a combination of such circuitries causing the apparatus to perform any of the embodiments of the invention. The control circuitry 102 may be implemented with a separate digital signal processor provided with suitable software embedded on a computer readable medium, or with a separate logic circuit, such as an application specific integrated circuit (ASIC). The control circuitry 102 may comprise an interface, such as computer port, for providing communication capabilities. The memory 104 may store software (PROG) executable by the at least one control circuitry 102.

The control circuitry 102 may comprise a device identification circuitry 107 for carrying out the device identification according to any of the embodiments presented. Thus, for example, the device identification may be based on the HIT or on IP-addresses for example. The circuitry 107 may also be responsible for deciding whether to establish a communication connection between the client 110 and the apparatus 100 or not. For example, the connection may be established when the mutual authentication of the devices 110 and 100 has been successfully performed.

The control circuitry 102 may comprise a client identification circuitry 108 for carrying out the client identification or verification of at least one client identifier according to any of the embodiments presented. Thus, for example, the client identification may be based on at least one identifier received through the established secure communication channel and the client identification data stored in the memory (CLIENT), for example. As said, the client identifier may comprise, e.g., biometric identifier(s).

The control circuitry 102 may comprise a certificate issuance circuitry 109 for determining whether or not to issue a certificate to the requesting client according to any of the embodiments presented. Thus, for example, the decision may be based on whether the all information required to be inputted by the client is given and whether the given data matches with the stored identification data. The decision may also be affected by the requirements of the service 122. As shown the memory 104 may store data related to at least one network service 122 (SERVICE). The data may indicate, for example, if there are any unwanted or unauthorized clients 111 and/or devices 110 as explained above.

The apparatus 100 may further comprise radio interface components (TRX) 101 providing the apparatus with radio communication capabilities with the radio access network, and more particularly towards the client's device 110 or the server 120. The radio interface components 101 may comprise standard well-known components such as amplifier, filter, frequency-converter, (de)modulator, and encoder/decoder circuitries and one or more antennas.

As explained earlier, the ID circuitry 106 may also be present in the VCI apparatus 100 for processing the at least identifier data received, for example. Further, the ID circuitry 106 may carry out the protocol applied in connection with requesting the certificate, such as the HIP-protocol between the client's device 110 and the VCI apparatus 100.

The apparatus 100 may also comprise a user interface 103 comprising, for example, at least one keypad, a microphone, a touch display, a display, a speaker, etc. The user interface 103 may be used to control the apparatus 100 by the user.

As said, the apparatus 100 may comprise the memory 104 connected to the control circuitry 102. However, memory may also be integrated to the control circuitry 102 and, thus, no memory 104 may be required. The memory 104 may be implemented using any suitable data storage technology, such as semiconductor based memory devices, flash memory, magnetic memory devices and systems, optical memory devices and systems, fixed memory and removable memory. The memory 104 may be for storing data related to client and device identifiers, the requirements and/or orders of notification set by at least one network service 122, the predetermined criteria for authorizing the client's device 110 to establish a communication connection, the predetermined rules regarding whether or not to issue the certificate, etc.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configure to carry out embodiments of any of the FIGS. 1 to 8. In an embodiment, the at least one processor 102, the memory 104, and the computer program code form an embodiment of processing means for carrying out the embodiments of the invention.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory including a computer program code, wherein the at least one memory and the computer program code are configured to, with the at least one processor, cause the apparatus at least to:
store identification data of a plurality of clients in the memory;
cause reception of information indicating at least one identifier of a device corresponding to a client requesting access to a service;
verify the identity of the client device on the basis of the received at least one identifier;
detect whether or not the identified device is authorized to communicate with the apparatus on the basis of first predetermined criteria;
upon detecting that the device is authorized, cause reception of information indicating at least one identifier of the client from the identified device;
verify the at least one identifier of the client on the basis of the received at least one identifier and the stored identification data; and
determine, on demand, whether or not to issue a certificate indicating the verifications on the basis of second predetermined criteria in order to enable the client to apply the certificate in accessing the service.

2. The apparatus of claim 1, wherein the apparatus is further caused to:
verify the identity of the client on the basis of the received at least one identifier and the stored identification data.

3. The apparatus of claim 1, wherein the apparatus is further caused to:
verify the identity of the client device on a network layer, which is a lower layer than an application layer.

4. The apparatus of claim 1, wherein the apparatus is further caused to:
store data indicating authorized clients and/or devices with respect to a plurality of network services in the memory, wherein the services are accessible on the application layer;
cause reception of information from a specific client, wherein the information indicates at least one service the client requests access to;
determine whether or not the client and/or device is an authorized client and/or device with respect to the at least one requested service based on the stored data; and
upon detecting that the client and/or device is an authorized client and/or device for at least one of the requested at least one service, configure the certificate to be valid only for those at least one service.

5. The apparatus of claim 1, wherein the identifier of the device is a self-verifiable cryptographic static or derived identifier.

6. The apparatus of claim 1, wherein the apparatus is further caused to:
authorize the client device to communicate with the apparatus only when the device is detected to be coupled to at least one predetermined auxiliary element, wherein the identities of the device and the at least one auxiliary element are verified.

7. The apparatus of claim 1, wherein the at least one identifier of the client comprises a biometric identifier.

8. The apparatus of claim 1, wherein the apparatus is further caused to:
configure the certificate to be applicable, by default, with respect to each service the client is accessing to.

9. The apparatus of claim 1, wherein the apparatus is further caused to:
determine the type of the at least one identifier; and
determine the reliability of the verification on the basis of the type of the at least one identifier and third predetermined criteria.

10. The apparatus of claim 9, wherein the apparatus is further caused to:
configure the certificate to comprise information indicating the type and/or reliability of the verification with respect to the at least one received client and/or device identifier in order to allow the service to determine whether to establish a communication connection to the device of the client or not.

11. The apparatus of claim 1, wherein the apparatus is further caused to:
configure the certificate to comprise information indicating the at least one identifier of the client and/or of the device.

12. The apparatus of claim 1, wherein the apparatus is further caused to:
configure the certificate to comprise at least one reference to one or more earlier issued certificates comprising information indicating at least one identifier of the client and/or of the device, wherein the information of the one or more earlier issued certificates is verified by the present apparatus or another apparatus.

13. The apparatus of claim 1, wherein the apparatus is further caused to:
store, in the memory, data indicating the reliability level of the verification required by at least one service; and
upon detecting that the reliability level of the verification does not meet the requirements with respect to the at least one identifier required by the at least one network service, determine not to issue a certificate or issue a certificate configured with at least one identifier having the required level of reliability.

14. The apparatus of claim 1, wherein the apparatus is further caused to:
assign a predetermined validity period in time domain for each identifier of the client and/or of the device.

15. The apparatus of claim 1, wherein the apparatus is further caused to:
cause reception of information from a service, wherein the information indicates predetermined characteristics with respect to clients and/or devices the service prefers to communicate with; and
upon detecting that at least one client and/or device matches with the indicated predetermined characteristics, cause transmission of information indicating the identity of the at least one client and/or device to the service.

16. An apparatus, comprising:
at least one processor and at least one memory including a computer program code, wherein the at least one memory and the computer program code are configured to, with the at least one processor, cause the apparatus at least to:
cause transmission of information indicating at least one identifier of the apparatus to a verification and certificate issuance apparatus;
cause transmission of information indicating at least one identifier of the client corresponding to the apparatus to the verification and certificate issuance apparatus;
request a certificate from the verification and certificate issuance apparatus;
cause reception of, on the basis of the request and provided identifiers, an issued certificate indicating the verifications of the identifiers; and
apply the certificate in accessing a service requiring at least part of the certificate.

17. The apparatus of claim 16, wherein the apparatus is further caused to:
extract at least one information piece from the issued certificate; and
generate a sub-certificate from the extracted at least one information piece.

18. A method, comprising:
storing identification data of a plurality of clients in the memory;
causing reception of information indicating at least one identifier of a device corresponding to a client requesting access to a service;
verifying the identity of the client device on the basis of the received at least one identifier;
detecting whether or not the identified device is authorized to communicate with the apparatus on the basis of first predetermined criteria;
upon detecting that the device is authorized, causing reception of information indicating at least one identifier of the client from the identified device;
verifying the at least one identifier of the client on the basis of the received at least one identifier and the stored identification data; and
determining, on demand, whether or not to issue a certificate indicating the verifications on the basis of second predetermined criteria in order to enable the client to apply the certificate in accessing the service.

19. A computer program product embodied on a distribution medium readable by a computer and comprising program instructions which, when loaded into an apparatus, execute the method according to claim 18.
